(19) United States
(12) Patent Application Publication
(10) Pub. No.: US 2005/0178255 A1
(43) Pub. Date: Aug. 18, 2005

(54) Device for eliminating end trimmings from a rool or the like

(75) Inventors: Angelo Benvenuti, Lucca (IT); Mario Gioni Chiocchetti, Lucca (IT); Mauro Gelli, Lucca (IT)

Correspondence Address: BREINER & BREINER, L.L.C., P.O. BOX 19290, ALEXANDRIA, VA, 22320-0290, US

(73) Assignee: Fabio Perini S.p.A

(21) Appl. No.: 10/516,820

(22) PCT Filed: Jun. 3, 2003
(86) PCT No.: PCT/IT03/00343

(30) Foreign Application Priority Data
Jun. 13, 2002 (IT) FI2002A000102

(51) Int. Cl. B26D 7/18

(52) U.S. Cl. 83/112; 83/153; 83/155.1

(57) ABSTRACT

The device comprises: a path (12) for the products, extending from products and trimmings entry position and a product deliver position, the trimmings being removed between said two positions; along said path, a movable flexible member (3) to retain and move the products and the trimmings and an opposite longitudinal fixed element (13) to retain said trimmings (R) extending along said path parallel to a first branch of said flexible member, at a distance from it to allow the products to advance in contact with said flexible member and with said fixed longitudinal element; at least a pusher (15) movable along a feed trajectory, to feed the series of products with the respective trimmings to said path (12). The pusher feeds the products and the trimmings between the flexible member and the fixed longitudinal element. The feed trajectory of the pusher intersects the path of the products between the flexible member (3) and the fixed longitudinal element (13), overlapping in the final stretch the path of the products in contact with said flexible member and said fixed longitudinal element.

### TECHNICAL FIELD

The invention relates to a device to remove scraps or end trimmings in the production of rolls of windable web materials, such as paper or the like, for example to produce rolls of toilet paper, kitchen towels or the like, produced by cutting longer rolls, or “logs”, into several parts.

More generally, the present invention relates to a device to eliminate trimmings or scraps from series or rows or products.

### STATE OF THE ART

The production of rolls of wound web material, such as toilet paper and the like, is performed by cutting a log, that is a starting roll having a diameter which is the same as the diameter of the final rolls but of a much greater length, into several parts. The log is thus cut into several parts by cutting machines, in order to obtain rolls of the desired length. During this operation head and tail trimmings or scraps are produced at both ends of the log, to discard the portion of edge material that is frequently damaged and in any case is wound irregularly. By cutting the ends rolls of the desired axial length are also obtained, even when the width of the initial web material is not an exact multiple of the height of the rolls.

These scraps or trimmings must be eliminated from the production line prior to packaging or wrapping to be recovered for recycling the material, if necessary, preventing clogging of the wrapping machines.

In order to eliminate these scraps various machines have been developed. Some machines use a procedure which makes use of pneumatic suction devices such as those described in WO-A-0162635, in EP-A-0607761, GB-A-2137918 or in U.S. Pat. No. 5,458,033.

Another system is the one described in U.S. Pat. No. 4,265,361 which allows all rolls of a size so small that they escape a grasping system positioned at an appropriate distance to fall outside the line.

WO-A-9732804 describes a system to eliminate scraps which is substantially based on the roll transport line being formed of three different stretches. The first stretch is characterized by the presence of a pusher that pushes the rolls fed from the cutting machine along a guide or channel. The second stretch is characterized by the simultaneous presence of two motorized conveyor belts arranged under the path of the rolls. These provide support for the rolls and transport them. The pusher is also present in this second stretch, and although it does not transport the rolls, which are transported by the two belts, it travels along part of this second stretch before being drawn back by the chain with which it is integral. The two belts of the second stretch of the path of the rolls are of different length and a bar forming a fixed support is positioned adjacent to the shorter belt. The bar is at a greater height than the two belts, one of which extends parallel to the bar.

The third stretch of the path of the rolls is therefore defined by one of the two belts, which extends along the feed path of the rolls beyond the second stretch, and which pulls the rolls. Moreover, said third stretch is also defined by the smooth surface formed by said bar, which provides a sliding support. Loss of balance caused by the asymmetrical thrust exerted by the belt on the roll resting on the belt on one side and on the fixed bar on the other, is only compensated if the roll is of an adequate length. Otherwise, the shorter roll, formed by the head or tail trimming, falls from the line and is discarded.

Although this prior art device offers considerable advantages, it is susceptible to further improvements, in particular to make the system to guide the rolls more efficient and reliable even at high speeds, and to reduce the overall path of the rolls.

IT-B-01292359 describes a system to eliminate head and tail trimmings from rows of cut rolls, which is based on the difference in the axial dimension of a roll destined for packaging and the axial dimension of a trimming. The rolls and trimmings are arranged on a conveyor line formed by two parallel belt means, positioned at adjustable distances from each other, advancing in the same direction and at the same speed. The reciprocal distance of the two belt means is equivalent to the axial dimension of the rolls and therefore is greater than the axial dimension of the trimmings.

The trimmings are therefore eliminated owing to the fact that the reduced axial dimensions of the trimmings prevent simultaneous contact with both belts, so that the lack of support consequently causes the trimmings to fall from the lower belt. In order to operate, the belt requires both the rolls and the trimmings to be fed into the path defined by the two overlapping belts, to be overturned and thus to lie on one of their flat faces. The device cannot function if the rolls and trimmings (or at least the latter) are fed in the position in which they are delivered from the cutting machine, that is with their axis parallel to the feed path and thus parallel to the two belts. Therefore, upstream the device requires a system to overturn the rolls and trimmings or at least the trimmings.

Similar problems may occur in other situations in which it is necessary to eliminate trimmings or scraps from series or rows of products obtained from cutting a semi-finished product of larger dimensions, or even simply from series of items or manufactured products fed along a processing line.

### OBJECTS AND SUMMARY OF THE INVENTION

The object of the present invention is to provide a device to remove scraps or head and tail trimmings in series of aligned rolls, which is simple and reliable also at high operating speeds.

More generally, the object of the present invention is to provide a device to eliminate waste or trimmings from rows or series of items or products along a processing line.

These and other objects and advantages, which shall become clear to those skilled in the art by reading the text hereunder, are obtained in substance with a device comprising: a path for the products; along said path, a movable flexible member to retain and move the products and trimmings and an opposite fixed longitudinal element; and at least a pusher movable along a feed trajectory, to feed the series of products and respective trimmings to said path. Characteristically, the pusher feeds the products and trimmings-directly between the flexible member and the fixed longitudinal element instead of (as is the case for example in WO-A-9732804) to an intermediate conveyor system. Moreover, the feed trajectory of the pusher intersects the path of the products between the flexible member and the fixed longitudinal element, overlapping in the final stretch the path of the rolls in contact with the flexible member and with the fixed longitudinal element.

The device is particularly advantageous and suitable to eliminate head and tail trimmings that are produced when cutting logs of wound web material. Hereinafter, specific and particular reference will be made to this application. However, the device may also be used in other circumstances, each time the trimmings or scraps found in the rows or series of products are of a size that can be overturned and discharged through the effect of the overturning torque applied by the device.

Operation of the device is based on the actions exerted by the contact surfaces on the rolls during transport. In particular the scraps or trimmings fall from the line when the overturning torque—which is produced through concurrence of the thrust on the roll by the flexible member and the friction of the sliding surface defined by the fixed longitudinal element—is not balanced by the torque exerted by the reaction forces exerted by the supports. Consequently, the trimming, which has a smaller axial length than the normal roll, overturns and falls. The trimming, which overturns due to the overturning torque, loses contact with one of the two supports defined by the flexible member and by the fixed longitudinal element and falls. On the contrary, the rolls do not fall from the feed path, as owing to their greater axial length the reaction forces exerted by the supports are sufficient to balance the overturning torque exerted by friction.

Overlapping between the trajectory of feed and thrust of the pusher and the stretch of path in which the rolls or other analogous products are in contact with the fixed longitudinal element considerably reduces, compared to prior solutions, the length of the path of the rolls. Moreover, it is impossible to reduce the number of mechanical elements, as a single flexible member and a single fixed longitudinal element are sufficient.

According to a preferred embodiment of the invention, the fixed longitudinal element is at a lower height than the flexible member. Placing the fixed longitudinal element in a lower position and the flexible member in a higher position prevents problems of mechanical interference between the advancing means of the pushers, usually a chain or other flexible member, and the feed means of the flexible member that pulls the rolls.

According to an improved embodiment of the invention, the pusher has a slot inside which the fixed longitudinal element penetrates during the movement with which the pusher feeds the series of rolls to the path between the flexible member and the fixed longitudinal element. In this way both the fixed longitudinal element and the pushers can be placed symmetrically in relation to the center-line of the feed path of the rolls. This provides optimum support of the rolls and a balanced thrust on them and, definitively, makes it possible to handle rolls of extremely soft and delicate web material, or in any case soft rolls, at high speed.

By positioning the fixed longitudinal element and the flexible member overlapping each other vertically, and preferably the former under the latter, the distance between the fixed longitudinal element and the section of the flexible member in contact with the rolls is substantially equal to or slightly less than the diameter of the rolls, also depending upon their greater or lesser compactness. The distance between the flexible member and the fixed longitudinal element may be adjustable to handle rolls also of variable diameters. By positioning the fixed longitudinal element and the flexible member overlapping each other vertically it is particularly simple to adjust the distance, as it may suffice to vertically adjust the higher of the two. The other may remain at a fixed height, and the configuration of the pusher(s) and means that move them may also remain the same.

Advantageously, according to a possible embodiment of the invention, the flexible member extends upstream of the fixed longitudinal element, in relation to the direction of feed of the rolls. In this way the pusher starts to push the rolls and the trimmings below the flexible member before they come into contact with the fixed longitudinal element. The feed speed of the flexible member is preferably greater than the feed speed imparted on the rolls by the pusher. Therefore, when the rolls and trimmings come into contact with the flexible member under the thrust of the pusher, they are spaced apart from each other to facilitate on the one hand discharge of the trimmings and on the other subsequent handling of the rolls.

To obtain efficient and reliable control of the rolls and reduce the risk of damaging their surface, according to an advantageous and preferred embodiment of the invention, the flexible member defines two adjacent supporting areas, for each of said rolls, said areas being parallel to the generatrices of the cylindrical surfaces of the rolls. This can be obtained for example by using two parallel belts, preferably with a circular cross-section. The two belts are preferably arranged symmetrically in relation to a vertical plane parallel to the fixed longitudinal element, which may be the plane of symmetry of this element.

Alternatively, and preferably, a single belt with two parallel longitudinal lips that form contact surfaces with the rolls can be used. These lips can be produced in a lighter and softer material than the body of the belt, which must have sufficient elongation strength. This reduces the risk of damage to the rolls caused by contact with the flexible member.

Alternatively, a single belt with a continuous contact surface with the rolls can be used.

In practice, and in a per se known way, preferably more than one pusher is provided, connected to a chain or another motorized flexible driving member. This may be driven around a wheel positioned under the feed path of the rolls between the flexible member and the fixed longitudinal element.

The fixed longitudinal element is produced in material with a low friction coefficient, for example a synthetic material such as Teflon® or the like.

### BRIEF DESCRIPTION OF THE FIGURES

The invention shall now be better understood by following the description and attached drawing showing a non-restrictive practical embodiment of the invention. In greater detail, in the drawing:

FIG. 1 shows in a longitudinal section the device in its main-components including the mechanism to adjust the height of the flexible member;

FIGS. 2 to 4 schematically show subsequent phases of the operation of the device;

FIG. 5 shows a section according to V-V in FIG. 1;

FIG. 6 shows the combination of forces on the rolls and on the trimmings during transport along the feed path in the device; and

FIG. 7 shows a cross-section similar to FIG. 5 of an alternative configuration that does not require the pusher and the fixed longitudinal element to interpenetrate.

### DETAILED DESCRIPTION OF THE PREFERRED EMBODIMENTS OF THE INVENTION

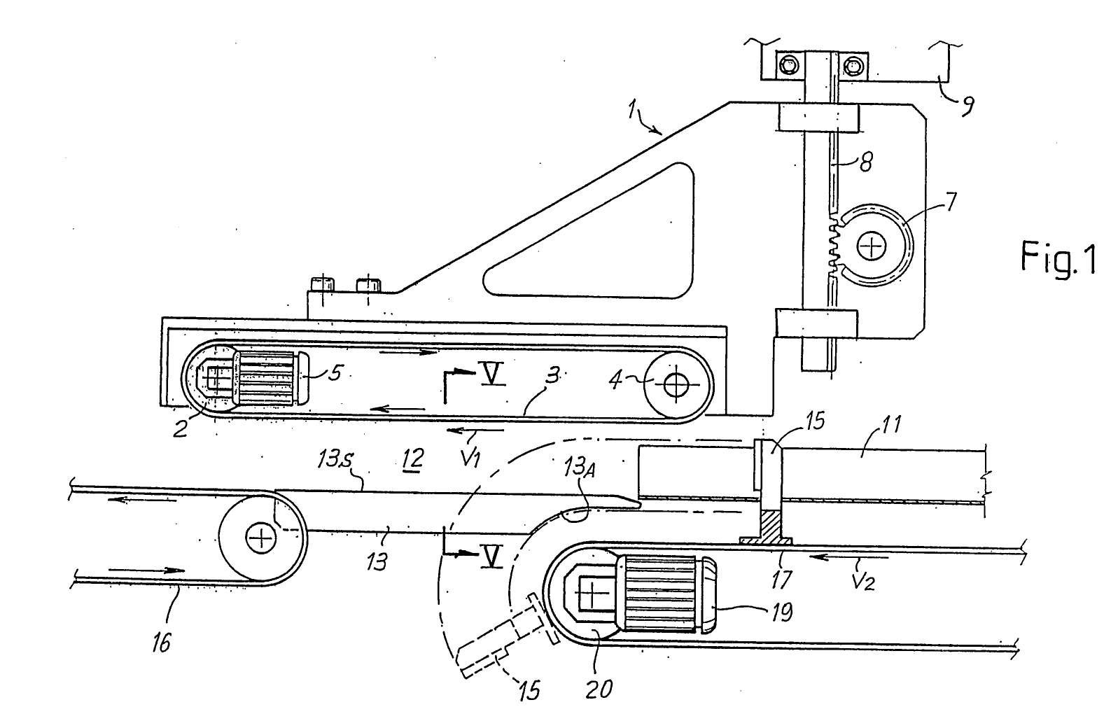

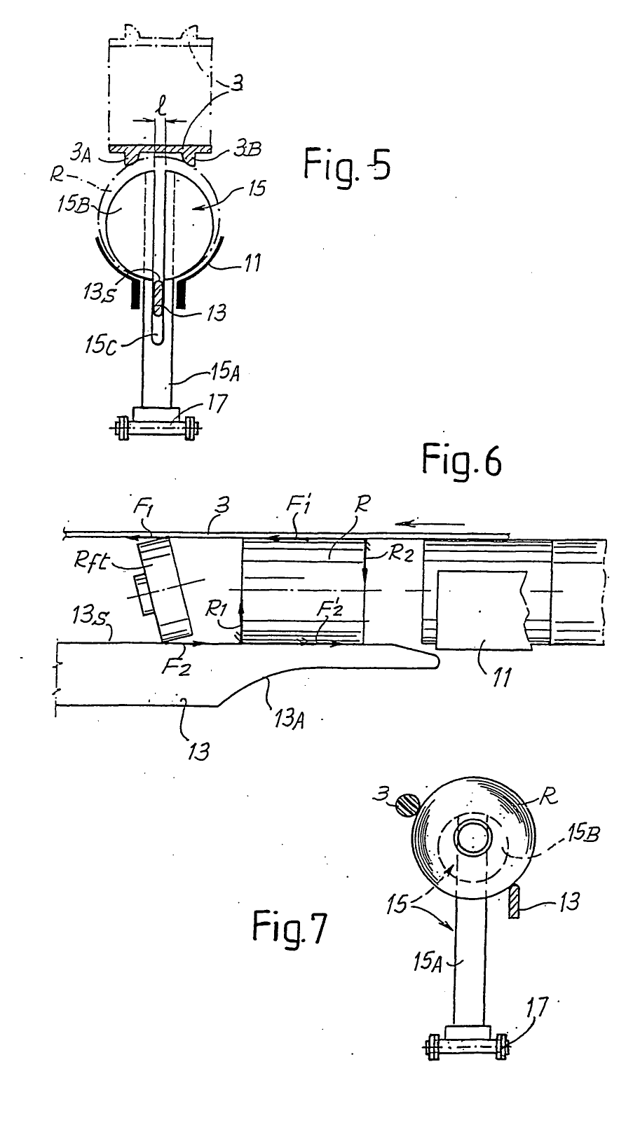

With initial reference to FIGS. 1 and 5, the device comprises a supporting structure (1) for a flexible member (3) and a motor (5) which operates and keeps it in movement at a constant speed V₁. The numbers (2) and (4) indicate the drive wheels of the flexible membr (3) which, in the example shown is constituted by a single belt. The belt has a pair of lips (3A, 3B) parallel to each other and extending along the entire longitudinal extension of the flexible member (3), the form of which is visible in a cross section in FIG. 5. The two lips (3A, 3B) may be produced in a softer material with a greater friction coefficient than the material constituting the body of the belt (3), to obtain sufficient grip on the rolls and trimmings without damaging the rolls.

The supporting structure (1) is integral with the axis of a toothed wheel (7) which meshes with a rack (8) provided on a specific fixed support (9). This allows the height of the flexible member (3) to be adjusted. Rotation of the toothed wheel (7) may be performed manually or through a specific actuator, not shown.

The rows of rolls (R) with respective head trimmings (Rft) and tail trimmings (Rfc) delivered from a cutting machine (only shown schematically and indicated with T in FIG. 2 and known per se) are fed along a channel or fixed guide (11) to be fed to a feed path (12) defined by the flexible member (3) and by an opposite fixed longitudinal element (13). The feed path (12) of the rolls extends from a feed area of the rolls, facing the channel or guide (11), to a delivery area, in which the rolls are delivered to a conveyor (16) which sends them to a processing machine, not shown.

As shown clearly in FIG. 5, in the example shown the fixed longitudinal element (13) is positioned under the flexible member (3) and substantially aligned with it on a vertical plane, which also constitutes the median plane of the rolls (R) and the trimmings (Rft, Rfc,) fed along the feed path (12). The distance between the flexible member (3) and the fixed longitudinal element (11) is such that the rolls (R) fed along the path (12) are in contact with the lips (3A, 3B) and with the upper surface of the fixed longitudinal element (13).

Along the guide or channel (11) transport of the rolls (R) and the trimmings (Rft, Rfc) is entrusted to a series of pushers (15) integral with a chain or other flexible member (17) kept in movement at a constant speed V₂ with V₂<V₁ by a specific motor (19) which rotates a drive wheel (20). This chain (17) makes the pushers (15) cyclically perform the same closed trajectory which also extends through the cutting machine.

As can be seen in particular in FIG. 5, each pusher (15) has a leg (15A) connected at one end to the chain (17) and integral at the other end with a thrust plate (15B) which comes into contact with the free surface of the tail trimming (Rfc) of a series of rolls and trimmings obtained by cutting a log.

A slot or groove (15C) extends through the plate (15B) and also along part of the longitudinal extension of the leg (15A). This groove allows the pusher (15) and the fixed longitudinal element (13) to interpenetrate with consequent overlapping of the feed path (12) of the rolls in contact with the fixed longitudinal element (13) with the trajectory of the pusher (15).

In the example shown, the fixed longitudinal element (13) has a laminar shape, with a rounded upper surface (13S) on which the rolls (R) rest and a thickness slightly lower than the width (1) of the slot or groove (15C) produced in the pushers (15), so that the fixed longitudinal element can penetrate without friction through the slot (15C). Moreover, in the area facing the channel or guide (11) the fixed longitudinal element (13) is rounded at the bottom (13A) to facilitate travel of the pushers (15) when they rotate around the axis of the wheel (20).

Operation of the device described hereinbefore shall now be described with reference in particular to FIGS. 2-4 and 6.

As shown in FIG. 2, each pusher (15) pulls a series of rolls (R) and respective head and tail trimmings (Rft, Rfc) along the fixed guide (11) at the speed V₂; these rolls and trimmings are obtained by cutting a log (L) in the cutting machine upstream, shown only schematically in FIG. 2, and indicated therein with (T), through which the guide extends (11). The cutting machine shown as an example is of the type comprising an arm rotating around an axis (A) and carrying a disc cutter (U) rotating around its own axis and thus orbiting around the axis (A).

As soon as each roll or trimming comes into contact with the flexible member (3) moving at a speed V₁>V₂, this spaces it from the subsequent roll as a function of the difference between the two speeds so that all the rolls constituting the series obtained by cutting a single log (L) are separated from one another. Linear acceleration of the trimmings and of the rolls can start before they come into contact with the fixed longitudinal element (13), as the flexible member (3) extends upstream of the fixed longitudinal element (13) in relation to the direction of feed of the rolls (R).

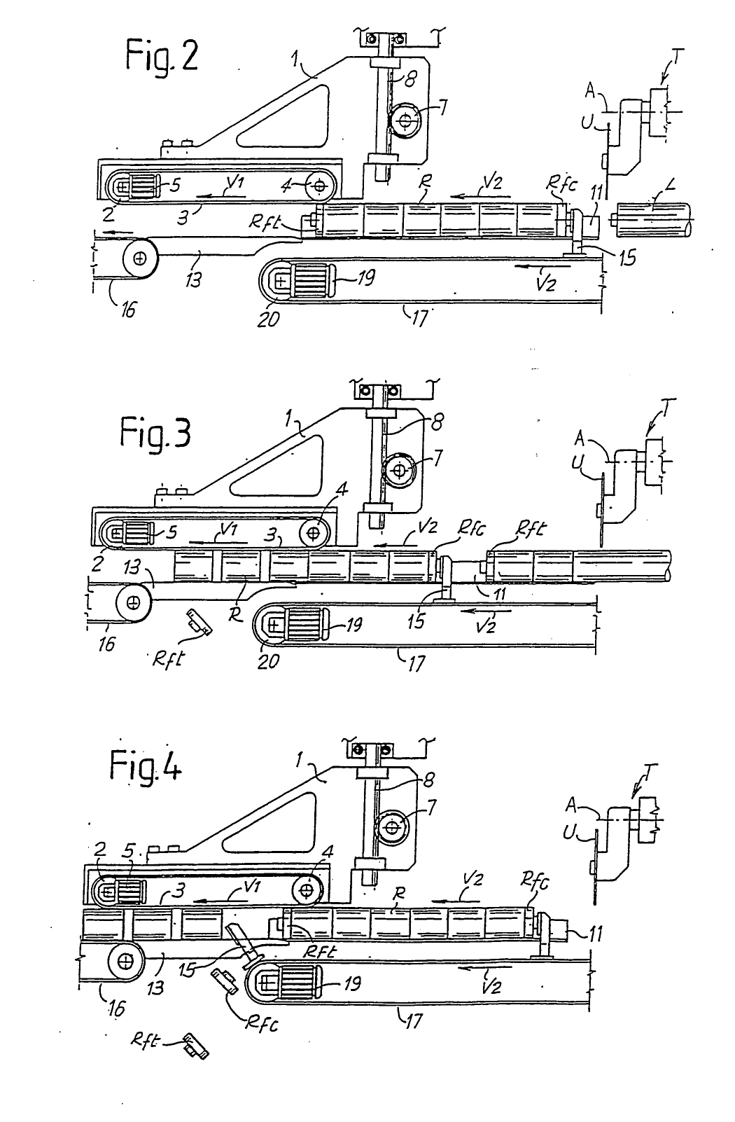

FIG. 3 shows how the head trimming (Rft) and the first rolls (R) of the series pushed by the pusher (15) and which are in contact with the flexible member (3) are spaced apart from one another thanks to the effect of the difference between the speed of the pusher (15) and the speed of the lower branch of the flexible member (3) in contact with the rolls (R).

When the trimmings and rolls come into contact with the fixed longitudinal element (13), as well as with the flexible member (3), forces are exerted on them to produce torques that attain the result of discharging the trimmings from the path (12) so that only the rolls (R) are delivered from the channel (11) to the conveyer (16). FIG. 6 schematically shows how the trimmings are eliminated, with reference to the head trimming (Rft). The head trimming (Rft) and the subsequent roll (R) are on the one side pushed with a force (F1, F1′) by the upper flexible member (3), through the effect of the friction force between it and the wound web material, and on the other are subjected to sliding friction (F2, F2′) which develops through sliding on the fixed longitudinal element (13). The different direction and the different points in which the results of these forces are applied determines a torque that tends to overturn both the rolls and the trimmings. However, in the case of the rolls, their greater longitudinal dimensions causes the onset of constraining reactions (R1, R2), the intensity and distribution of which produce a torque capable of opposing overturning. This does not occur in the trimmings due to their lower axial dimension. The constraining reactions do not produced sufficient torque to balance the overturning torque.

The result is that while the rolls continue to be fed along the path (12) between the flexible member (3) and the fixed longitudinal element (13) to reach the conveyor (16), the trimmings—due to the overturning—lose the central support constituted by the flexible member (3) and fall from the only support constituted by said fixed longitudinal element (13). The fall is facilitated by the rounded shape (in cross-section) of this element.

The sequence in FIGS. 2 and 4 shows how, according to this principle, first elimination of the head trimming (Rft) and subsequently of the tail trimming (Rfc) take place.

After feeding the last element of the series (that is the tail trimming Rfc) under the flexible member (3), the pusher (15) continues its trajectory and encounters the fixed longitudinal element (13). This penetrates inside the form of the pusher through the slot (15C). This penetration allows the pusher to feed the series of rolls and trimmings beyond the start of the fixed longitudinal element (13).

The spacing between the head and tail trimmings and adjacent rolls, obtained thanks to the difference between the speeds V₁ e V₂, guarantees in any case elimination of the trimmings which otherwise could remain resting against the adjacent roll. This is particularly true for the head trimming which could reach the conveyor (16) without overturning through the effect of the thrust of the first roll (R) of the series.

In an alternative configuration, shown in section in FIG. 7, the fixed longitudinal element and the flexible member, again indicated with (13) and (3) respectively, are positioned on any chord of the front section of the rolls and at a distance from the vertical line of symmetry of this section so that the pusher (15) in its action to feed the rolls to the path (12) between the flexible member (3) and the fixed longitudinal element (13) does not interfere with them.

In this case retention of the rolls by the fixed longitudinal element (13) and the flexible member (3) is not optimum, as these elements are not vertically overlapping. Moreover, the plate 15B of the pusher must have a reduced diameter in order to pass under the fixed longitudinal element (13) when it has to pass from the upper section to the lower section of the chain path (17). This makes operation of the device less reliable. It must also be said that in this configuration adaptation to different diameters of the rolls requires adjustment both of the flexible member (3) and of the fixed longitudinal element (13).

It must be understood that the arrangement described above may be multiple, that is two or more parallel paths may be provided for a corresponding number of series of rolls coming from a corresponding number of channels of a multiple cutting machine, according to arrangements known per se. In this case the configuration in FIGS. 1-5 is preferable, also because it has lower overall transverse dimensions and therefore allows several roll feed channels to be positioned side by side without an excessive increase in the overall dimensions.

It is understood that the drawing only shows a possible embodiment of the invention, which may vary in forms and arrangements without however departing from the scope of the concept underlying the invention. Any reference numerals in the attached claims are provided for the sole purpose of facilitating reading in the light of the description hereinbefore and the attached drawings and do not limit the scope of protection.

1. A device to eliminate trimmings or scraps from series of products comprising:
a path for the products, extending from a product and trimmings entry position and a product delivery position, the trimmings being removed between said entry position and said delivery position;
along said path, a movable flexible member to retain and move the products and the trimmings and an opposite longitudinal fixed element to retain said trimmings extending along said path parallel to a first branch of said flexible member, at a distance from said first branch of said flexible member to allow the products to advance in contact with said flexible member and with said fixed longitudinal element;
at least one pusher movable along a feed trajectory, to feed the series of products with the trimmings to said path;
wherein the pusher feeds the products and the trimmings between said flexible member and said fixed longitudinal element; and wherein said feed trajectory of the pusher intersects the path of the products between said flexible member and said fixed longitudinal element, overlapping in a final stretch of the path of the products in contact with said flexible member and said fixed longitudinal element.

2. Device as claimed in claim 1, wherein said products are rolls of wound web material and said trimmings are head and tail trimmings produced by cutting rolls or logs.

3. Device as claimed in claim 1, wherein said fixed longitudinal element is at a lower height than said flexible member.

4. Device as claimed in claim 1, wherein said at least one pusher has a slot inside which said fixed longitudinal element penetrates during movement with which the pusher feeds the series of products to said path between the flexible member and the fixed longitudinal element.

5. Device as claimed in claim 3, wherein said first branch of the flexible member is approximately vertically overlapping said fixed longitudinal element.

6. Device as claimed in claim 2, wherein the distance between the fixed longitudinal element and the first branch of the flexible member is substantially equal to a diameter of the rolls.

7. Device as claimed in claim 1, wherein said flexible member extends upstream of said fixed longitudinal element, in relation to a direction of feed of the products.

8. Device as claimed in claim 1, wherein said flexible member has a feed speed, along said path, greater than a feed speed imparted on the products by said at least one pusher.

9. Device as claimed in claim 1, wherein the distance between the flexible member and the fixed longitudinal element is adjustable.

10. Device as claimed in claim 1, wherein said flexible member defines two adjacent supporting areas for each of said products, said areas being parallel to a direction of feed of said products.

11. Device as claimed in claim 1, wherein said flexible member comprises at least a belt.

12. Device as claimed in claim 11, wherein said belt has two parallel lips defining two adjacent supporting lines for the products.

13. Device as claimed in claim 1, wherein said flexible member comprises two parallel belts, each belt forming one of the two supporting lines.

14. Device as claimed in claim 13, wherein said two parallel belts are positioned symmetrically in relation to a vertical plane parallel to said fixed longitudinal element.

15. Device as claimed in claim 1, wherein said at least one pusher is carried by a second flexible member, driven around a wheel positioned under said path between the flexible member and the fixed longitudinal element, the second flexible member defining a closed path along which said at least one pusher is made to advance.

16. Device as claimed in claim 15, wherein a channel is positioned upstream of said fixed longitudinal element to feed the products pushed by said at least one pusher.

17. Device as claimed in claim 1, wherein said fixed longitudinal element comprises a synthetic material with a low friction coefficient.

18. Device as claimed in claim 17, wherein said synthetic material is polytetrafluoroethylene (Teflon).

19. Device as claimed in claim 1, wherein said fixed longitudinal element has a laminar extension, with a rounded surface in contact with the products.

20. Device as claimed in claim 19, wherein said fixed longitudinal element has a reduced height in proximity to the product and trimmings entry position.

21. Device as claimed in claim 4, wherein in a first stretch of said path, in proximity to a product feed area, said fixed longitudinal element has a rounded form to allow travel of said at least one pusher.

22. Device as claimed in claim 1, wherein said fixed longitudinal element and said flexible member are positioned on opposite sides of a vertical median plane of symmetry of the products fed along said path; the distance between said fixed longitudinal element and said flexible member in a plan projection is lower than a transverse plan dimension of said products; and the dimension and form of said pusher are such that during action of said pusher to feed the products to said path between the flexible member and the fixed longitudinal element the pusher does not interfere with said fixed longitudinal element and said flexible member.

23. A cutting machine to cut logs of web material into rolls, comprising a cutting tool and means to feed the rolls, wherein the means to feed the rolls comprises a device to eliminate trimmings as claimed in one of claims 1-22.
